(19) United States
(12) Patent Application Publication
(10) Pub. No.: US 2026/0362316 A1
(43) Pub. Date: Nov. 12, 2026

(54) Methods and Apparatus for Dynamic Periodic and Semi-Persistent (SP) Signaling Adaptation in Wireless Communication

(71) Applicant: Apple Inc., Cupertino, CA (US)

(72) Inventors: Hong HE, San Jose, CA (US); Dawei ZHANG, Saratoga, CA (US); Wei ZENG, Saratoga, CA (US); Chunxuan YE, San Diego, CA (US); Sigen YE, San Diego, CA (US); Haitong SUN, Saratoga, CA (US); Jie CUI, San Jose, CA (US)

(21) Appl. No.: 19/103,074

(22) PCT Filed: Aug. 11, 2023
(86) PCT No.: PCT/US2023/030053

§ 371 Date: Feb. 11, 2025

Related U.S. Application Data
(60) Provisional application No. 63/371,099, filed on Aug. 11, 2022.

(51) Int. Cl. H04W 52/02

(52) U.S. Cl. CPC H04W 52/0206; H04W 52/0216

(57) ABSTRACT

received from a base station, a system information block (SIB) comprising information related to a downlink control information (DCI) that is transmitted by the base station and decode, based on signaling received from the base station, the DCI indicating when the base station is to utilize a power saving mode comprising at least one time interval during which the base station discontinues the transmission or reception of a type of periodic or semi-persistent signal.

### PRIORITY/INCORPORATION BY REFERENCE

This application claims priority to U.S. Provisional Application Ser. No. 63/371,099 filed on Aug. 11, 2022, and entitled “Methods and Apparatus for Dynamic Periodic and Semi-Persistent (SP) Signaling Adaptation in Wireless Communication,” the entirety of which is incorporated herein by reference.

### BACKGROUND

Typically, energy saving mechanisms are designed to conserve power at a user equipment (UE). However, energy consumption is also a concern on the network side and network power saving mechanisms may also be utilized. It has been identified that there is a need for techniques configured to support the implementation of network power saving mechanisms.

### SUMMARY

Some exemplary embodiments are related to an apparatus of a user equipment (UE), the apparatus having processing circuitry configured to decode, based on signaling received from a base station, a system information block (SIB) comprising information related to a downlink control information (DCI) that is transmitted by the base station and decode, based on signaling received from the base station, the DCI indicating when the base station is to utilize a power saving mode comprising at least one time interval during which the base station discontinues the transmission or reception of a type of periodic or semi-persistent signal.

Other exemplary embodiments are related to a processor configured to decode, based on signaling received from a base station, a system information block (SIB) comprising information related to a downlink control information (DCI) that is transmitted by the base station and decode, based on signaling received from the base station, the DCI indicating when the base station is to utilize a power saving mode comprising at least one time interval during which the base station discontinues the transmission or reception of a type of periodic or semi-persistent signal.

Still further exemplary embodiments are related to an apparatus of a base station, the apparatus having processing circuitry configured to configure transceiver circuitry to transmit a system information block (SIB) comprising information related to a downlink control information (DCI) that is transmitted to a user equipment (UE) and configure transceiver circuitry to transmit the DCI indicating when the base station is to utilize a power saving mode comprising at least one time interval during which the base station discontinues the transmission or reception of a type of periodic or semi-persistent signal.

Additional exemplary embodiments are related to a processor configured to configure transceiver circuitry to transmit a system information block (SIB) comprising information related to a downlink control information (DCI) that is transmitted to a user equipment (UE) and configure transceiver circuitry to transmit the DCI indicating when the base station is to utilize a power saving mode comprising at least one time interval during which the base station discontinues the transmission or reception of a type of periodic or semi-persistent signal.

### BRIEF DESCRIPTION OF THE DRAWINGS

FIG. 1 shows an exemplary network arrangement according to various exemplary embodiments.

FIG. 2 shows an exemplary user equipment (UE) according to various exemplary embodiments.

FIG. 3 shows an exemplary base station according to various exemplary embodiments.

FIG. 4 shows a signaling diagram for dynamically switching on and off periodic/semi-persistent (SP) signaling for network power saving according to various exemplary embodiments.

FIG. 5 shows an example of cycle-based on-off PSM operation according to various exemplary embodiments.

FIG. 6 shows an exemplary downlink control information (DCI) format 2_X according to various exemplary embodiments.

FIG. 7 shows a single on-off (OO)-power saving mode (PSM) pattern according to various exemplary embodiments.

FIG. 8 shows OO-PSM combination comprising multiple OO-PSM patterns according to various exemplary embodiments.

FIG. 9 shows a table according to various exemplary embodiments.

### DETAILED DESCRIPTION

The exemplary embodiments may be further understood with reference to the following description and the related appended drawings, wherein like elements are provided with the same reference numerals. The exemplary embodiments introduce techniques configured to support the implementation of network power saving mechanisms.

The exemplary embodiments are described with regard to a user equipment (UE). However, reference to a UE is merely provided for illustrative purposes. The exemplary embodiments may be utilized with any electronic component that may establish a connection to a network and is configured with the hardware, software, and/or firmware to exchange information and data with the network. Therefore, the UE as described herein is used to represent any electronic component.

The exemplary embodiments are also described with regard to a fifth generation (5G) New Radio (NR) network and a next generation node B (gNB). However, reference to a 5G NR network and a gNB is merely provided for illustrative purposes. The exemplary embodiments may be utilized with any appropriate type of network and base station.

The exemplary embodiments are further described with regard to a network power saving mode (PSM). Throughout this description, the term “PSM” may be used to refer to a time interval during which the gNB utilizes a sleep mode to conserve power. Reference to PSM or a sleep mode does not necessarily mean putting processing components, transmitting components and/or receiving components for a cell operated by the gNB to sleep, in hibernation, or in deactivation. Instead, the PSM described herein relates to conserving power by discontinuing at least a subset of data exchange processing functionality associated with operating as a base station. Outside of the PSM, the gNB may use an active mode of data exchange processing to transmit and/or receive the traffic that is not exchanged during the PSM. However, reference to the term “PSM” is merely provided for illustrative purposes, different entities may refer to a similar concept by a different name.

The following non-limiting examples describe some types of operations that may be discontinued during the PSM. The gNB may discontinue transmitting physical downlink shared channel (PDSCH), the gNB may discontinue transmitting periodic tracking reference signals (TRS), the gNB may discontinue receiving physical uplink shared channel (PUSCH) and the gNB may discontinue transmitting and receiving various different types of periodic/semi-persistent (SP) signals (e.g., synchronization signal blocks (SSBs), physical random access channel (PRACH) resources, periodic channel state information (CSI) reports, periodic CSI-reference signals (RS), semi-persistent (SP) CSI-RS, periodic sounding reference signals (SRS), SP SRS, etc.).

When the gNB is in the PSM, the UE may be configured to discontinue or omit various different types of operations. That is, the UE may adapt its behavior to the PSM of the gNB to ensure that the UE does not perform operations to transmit a signal that will not actually be received by the gNB due to PSM or operations to receive a signal that will not actually be transmitted by the gNB due to PSM.

The following non-limiting examples describe exemplary UE behavior while the gNB is in PSM. The UE may discontinue transmitting PRACH resources during a random access channel (RACH) occasion, the UE may not attempt to measure CSI-RS resources (e.g., periodic CSI-RS, SP CSI-RS, TRS), the UE may discontinue beam failure detection measurements, the UE may discontinue beam failure recovery measurements, the UE may discontinue reporting periodic/SP/aperiodic (AP) CSI on and for a serving cell, the UE may discontinue transmitting configured grant PUSCH, the UE may discontinue monitoring physical downlink control channel (PDCCH) on and for a serving cell, the UE may discontinue transmitting PUCCH on the serving cell (including scheduling request (SR) physical uplink control channel (PUCCH) transmission), the UE may discontinue transmitting periodic/SP SRS on the serving cell and the UE may not receive SSB. However, these examples are provided for illustrative purposes, the UE behavior may adapt to the PSM configuration. The exemplary embodiments do not require that the UE behave in any particular manner during PSM.

According to some aspects, the exemplary embodiments introduce techniques for dynamically switching on and off certain types of periodic/semi-persistent signaling for network power saving. In addition, the exemplary embodiments include signaling techniques for notifying the UE of when PSM is to be used by the gNB. Providing this type of information enables the UE to adapt its behavior to the network power saving techniques used by the gNB. Each of these exemplary embodiments will be described in detail below. The exemplary embodiments may be utilized independently from one another, in conjunction with other currently implemented network power saving techniques, in conjunction with future implementations of network power saving techniques or independently from other network power saving techniques.

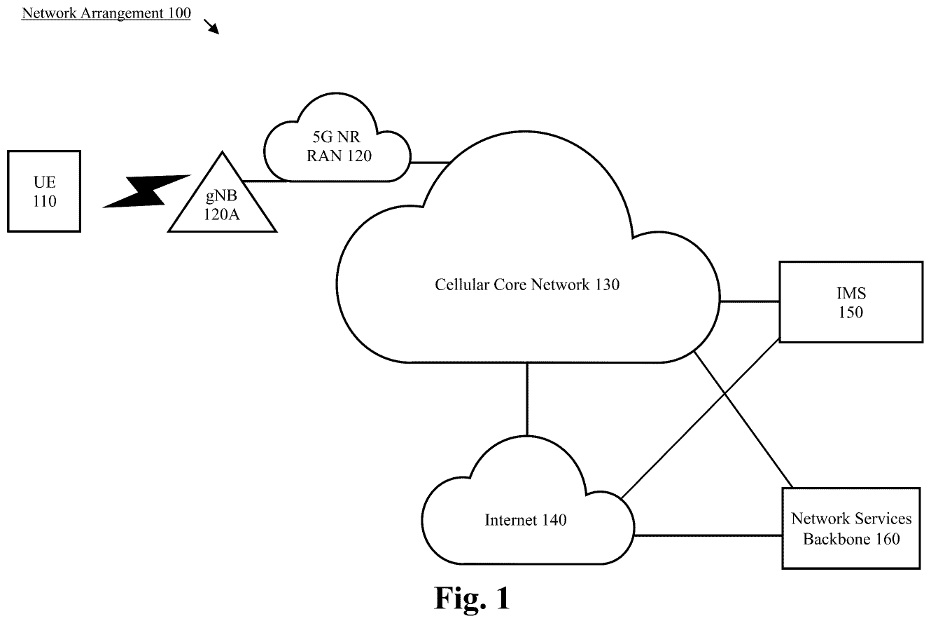

FIG. 1 shows an exemplary network arrangement 100 according to various exemplary embodiments. The exemplary network arrangement 100 includes a UE 110. Those skilled in the art will understand that the UE 110 may be any type of electronic component that is configured to communicate via a network, e.g., mobile phones, tablet computers, desktop computers, smartphones, phablets, embedded devices, wearables, Internet of Things (IOT) devices, etc. It should also be understood that an actual network arrangement may include any number of UEs being used by any number of users. Thus, the example of a single UE 110 is merely provided for illustrative purposes.

The UE 110 may be configured to communicate with one or more networks. In the example of the network configuration 100, the network with which the UE 110 may wirelessly communicate is a 5G NR radio access network (RAN) 120. However, the UE 110 may also communicate with other types of networks (e.g., 5G cloud RAN, a next generation RAN (NG-RAN), a long term evolution (LTE) RAN, a legacy cellular network, a wireless local area network (WLAN), etc.) and the UE 110 may also communicate with networks over a wired connection. With regard to the exemplary embodiments, the UE 110 may establish a connection with the 5G NR RAN 120. Therefore, the UE 110 may have a 5G NR chipset to communicate with the NR RAN 120.

The 5G NR RAN 120 may be a portion of a cellular network that may be deployed by a network carrier (e.g., Verizon, AT&T, T-Mobile, etc.). The 5G NR RAN 120 may include, for example, cells or base stations (Node Bs, eNodeBs, HeNBs, eNBS, gNBs, gNodeBs, macrocells, microcells, small cells, femtocells, etc.) that are configured to send and receive traffic from UEs that are equipped with the appropriate cellular chip set.

Those skilled in the art will understand that any association procedure may be performed for the UE 110 to connect to the 5G NR RAN 120. For example, as discussed above, the 5G NR RAN 120 may be associated with a particular cellular provider where the UE 110 and/or the user thereof has a contract and credential information (e.g., stored on a SIM card). Upon detecting the presence of the 5G NR RAN 120, the UE 110 may transmit the corresponding credential information to associate with the 5G NR RAN 120. More specifically, the UE 110 may associate with a specific base station, e.g., the gNB 120A.

The network arrangement 100 also includes a cellular core network 130, the Internet 140, an IP Multimedia Subsystem (IMS) 150, and a network services backbone 160. The cellular core network 130 may refer an interconnected set of components that manages the operation and traffic of the cellular network. It may include the evolved packet core (EPC) and/or the 5G core (5GC). The cellular core network 130 also manages the traffic that flows between the cellular network and the Internet 140. The IMS 150 may be generally described as an architecture for delivering multimedia services to the UE 110 using the IP protocol. The IMS 150 may communicate with the cellular core network 130 and the Internet 140 to provide the multimedia services to the UE 110. The network services backbone 160 is in communication either directly or indirectly with the Internet 140 and the cellular core network 130. The network services backbone 160 may be generally described as a set of components (e.g., servers, network storage arrangements, etc.) that implement a suite of services that may be used to extend the functionalities of the UE 110 in communication with the various networks.

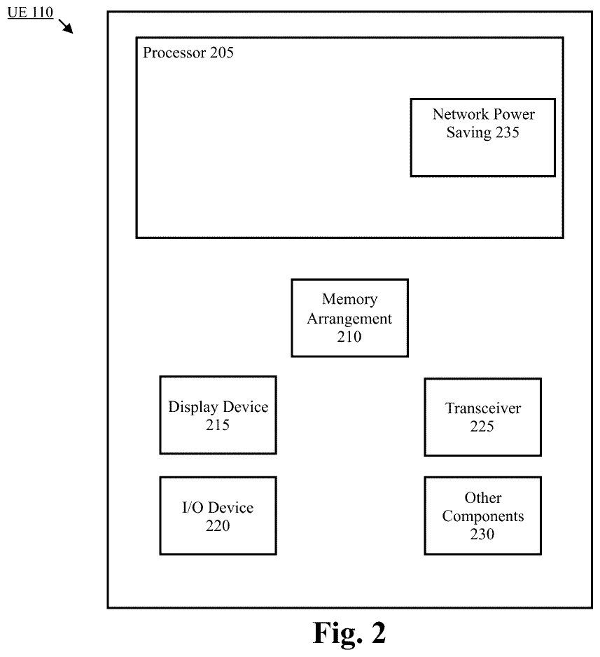

FIG. 2 shows an exemplary UE 110 according to various exemplary embodiments. The UE 110 will be described with regard to the network arrangement 100 of FIG. 1. The UE 110 may include a processor 205, a memory arrangement 210, a display device 215, an input/output (I/O) device 220, a transceiver 225 and other components 230. The other components 230 may include, for example, an audio input device, an audio output device, a power supply, a data acquisition device, ports to electrically connect the UE 110 to other electronic devices, etc.

The processor 205 may be configured to execute a plurality of engines of the UE 110. For example, the engines may include a network power saving engine 235. The network power saving engine 235 may perform various operations related network power saving such as, but not limited to, receiving configuration information related to PSM operation, receiving downlink control information (DCI) and adapting the UE 110 behavior to the PSM operation.

The above referenced engine 235 being an application (e.g., a program) executed by the processor 205 is merely provided for illustrative purposes. The functionality associated with the engine 235 may also be represented as a separate incorporated component of the UE 110 or may be a modular component coupled to the UE 110, e.g., an integrated circuit with or without firmware. For example, the integrated circuit may include input circuitry to receive signals and processing circuitry to process the signals and other information. The engines may also be embodied as one application or separate applications. In addition, in some UEs, the functionality described for the processor 205 is split among two or more processors such as a baseband processor and an applications processor. The exemplary embodiments may be implemented in any of these or other configurations of a UE.

The memory arrangement 210 may be a hardware component configured to store data related to operations performed by the UE 110. The display device 215 may be a hardware component configured to show data to a user while the I/O device 220 may be a hardware component that enables the user to enter inputs. The display device 215 and the I/O device 220 may be separate components or integrated together such as a touchscreen.

The transceiver 225 may be a hardware component configured to establish a connection with the 5G NR-RAN 120, an LTE-RAN (not pictured), a legacy RAN (not pictured), a WLAN (not pictured), etc. Accordingly, the transceiver 225 may operate on a variety of different frequencies or channels (e.g., set of consecutive frequencies). The transceiver 225 may encompass an advanced receiver (e.g., E-MMSE-RC, R-ML, etc.) for MU-MIMO. The transceiver 225 includes circuitry configured to transmit and/or receive signals (e.g., control signals, data signals). Such signals may be encoded with information implementing any one of the methods described herein. The processor 205 may be operably coupled to the transceiver 225 and configured to receive from and/or transmit signals to the transceiver 225. The processor 205 may be configured to encode and/or decode signals (e.g., signaling from a base station of a network) for implementing any one of the methods described herein.

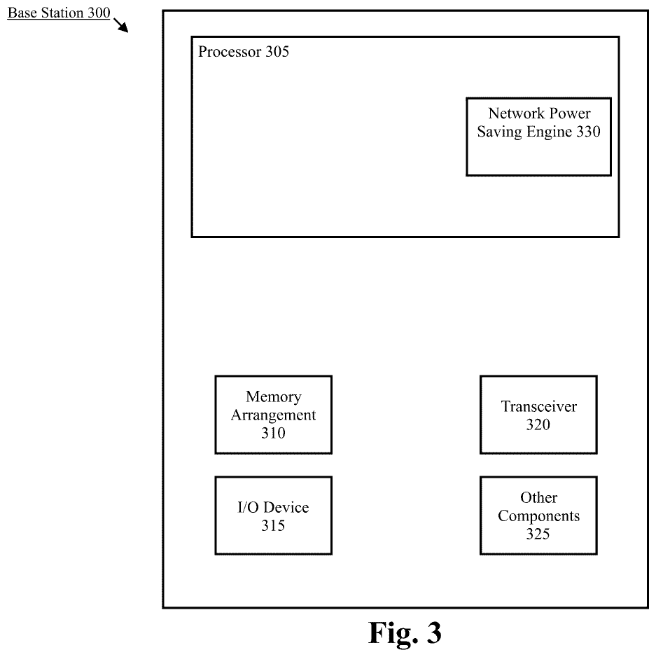

FIG. 3 shows an exemplary base station 300 according to various exemplary embodiments. The base station 300 may represent the gNB 120A or any other access node through which the UE 110 may establish a connection and manage network operations.

The base station 300 may include a processor 305, a memory arrangement 310, an input/output (I/O) device 315, a transceiver 320 and other components 325. The other components 325 may include, for example, an audio input device, an audio output device, a battery, a data acquisition device, ports to electrically connect the base station 300 to other electronic devices and/or power sources, etc.

The processor 305 may be configured to execute a plurality of engines for the base station 300. For example, the network power saving engine 330 may perform various operations related network power saving such as, but not limited to, transmitting PSM configuration information, transmitting DCI and switching on and off PSM.

The above noted engine 330 being an application (e.g., a program) executed by the processor 305 is only exemplary. The functionality associated with the engine 330 may also be represented as a separate incorporated component of the base station 300 or may be a modular component coupled to the base station 300, e.g., an integrated circuit with or without firmware. For example, the integrated circuit may include input circuitry to receive signals and processing circuitry to process the signals and other information. In addition, in some base stations, the functionality described for the processor 305 is split among a plurality of processors (e.g., a baseband processor, an applications processor, etc.). The exemplary embodiments may be implemented in any of these or other configurations of a base station.

The memory 310 may be a hardware component configured to store data related to operations performed by the base station 300. The I/O device 315 may be a hardware component or ports that enable a user to interact with the base station 300. The transceiver 320 may be a hardware component configured to exchange data with the UE 110 and any other UE in the network arrangement 100.

The transceiver 320 may operate on a variety of different frequencies or channels (e.g., set of consecutive frequencies). Therefore, the transceiver 320 may include one or more components (e.g., radios) to enable the data exchange with the various networks and UEs. The transceiver 320 includes circuitry configured to transmit and/or receive signals (e.g., control signals, data signals). Such signals may be encoded with information implementing any one of the methods described herein. The processor 305 may be operably coupled to the transceiver 320 and configured to receive from and/or transmit signals to the transceiver 320. The processor 305 may be configured to encode and/or decode signals (e.g., signaling from a UE) for implementing any one of the methods described herein.

According to some aspects, the exemplary embodiments introduce techniques for dynamically switching on and off certain types of periodic and semi-persistent (SP) signaling for network power saving. In addition, the exemplary embodiments include signaling techniques for providing the UE with information related to PSM operation. The exemplary embodiments may enable the UE 110 to determine when the gNB 120A is in PSM and adapt its behavior accordingly.

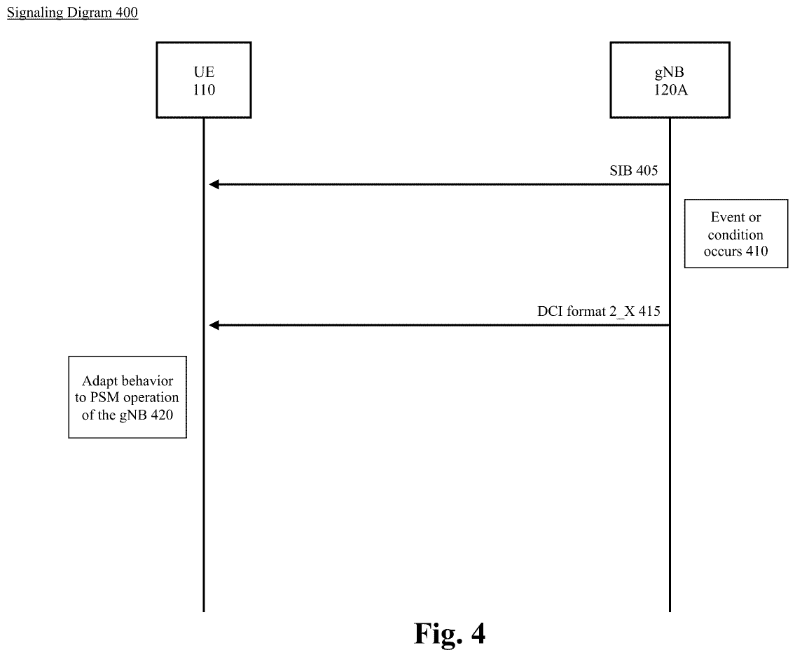

FIG. 4 shows a signaling diagram 400 for dynamically switching on and off periodic/SP signaling for network power saving according to various exemplary embodiments. The signaling diagram 400 is described with regard to the network arrangement 100 of FIG. 1 and includes the UE 110 and the gNB 120A.

The exemplary embodiments introduce a new DCI format for providing UEs with information related to PSM operation. Throughout this description, the new DCI format may be referred to as “DCI format 2_X.” However, reference to DCI format 2_X is merely provided for illustrative purposes, the 2_X classification provided herein may serve as a placeholder. In an actual deployment scenario, the new DCI format may be assigned any appropriate number or label.

In 405, the gNB 120A transmits a system information block (SIB). The SIB may include information that enables the UE 110 to subsequently receive DCI format 2_X via downlink control signaling. To provide some examples, the SIB may comprise parameters such as, but not limited to, a payload size of DCI format 2_X, one or more search space sets that may be used to monitor physical downlink control channel (PDCCH) for DCI format 2_X on an initial downlink bandwidth part (BWP) of a serving cell (e.g., gNB 120A) and a PDCCH monitoring periodicity.

To provide another example, the SIB may include a PSM-radio network temporary identifier (RNTI). Throughout this description, the term “PSM-RNTI” may represent a new RNTI that is used to scramble the DCI format 2_X introduced herein. However, reference to the term PSM-RNTI is merely provided for illustrative purposes, different entities may refer to a similar concept by a different name. In some embodiments, instead of being provided via SIB, the RNTI for DCI format 2_X may be hard encoded in the 3GPP specifications or provided in any other appropriate manner. In addition, the exemplary embodiments are not required to utilize PSM-RNTI, an already defined RNTI or a future implementation of an RNTI may also be configured for DCI format 2_X.

In 410, a condition or event occurs which triggers the gNB 120A to enter PSM. In this example, PSM may comprise discontinuing at least a subset of operations related to transmitting and/or receiving certain types of periodic/SP signals. However, the manner in which the gNB 120A is triggered to enter PSM is beyond the scope of exemplary embodiments.

Instead, the exemplary embodiments introduce techniques for signaling information related to PSM operation.

In 415, the gNB 120A transmits DCI format 2_X to the UE 110. The DCI format 2_X may provide the UE 110 with information related to PSM operation. This information may enable the UE 110 to adapt its behavior to the PSM of the gNB 120A. While the exemplary embodiments are described with regard to DCI format 2_X, the exemplary embodiments do not require the use of a new DCI format. Instead, one or more previously defined DCI formats may be used to convey the same type of information described herein with regard to DCI format 2_X.

In 420, the UE 110 may adapt its behavior to PSM operation of the gNB 120A. For example, the UE 110 may discontinue transmitting and/or expecting to receive certain types of periodic/SP signaling when PSM is being utilized by the gNB 120A.

The signaling diagram 400 provides a general overview of the type of signaling that may be utilized to provide the UE 110 with information related to PSM operation at the gNB 120A. Additional details of PSM operation and the type of information that may be provided to the UE 110 are provided in various example below.

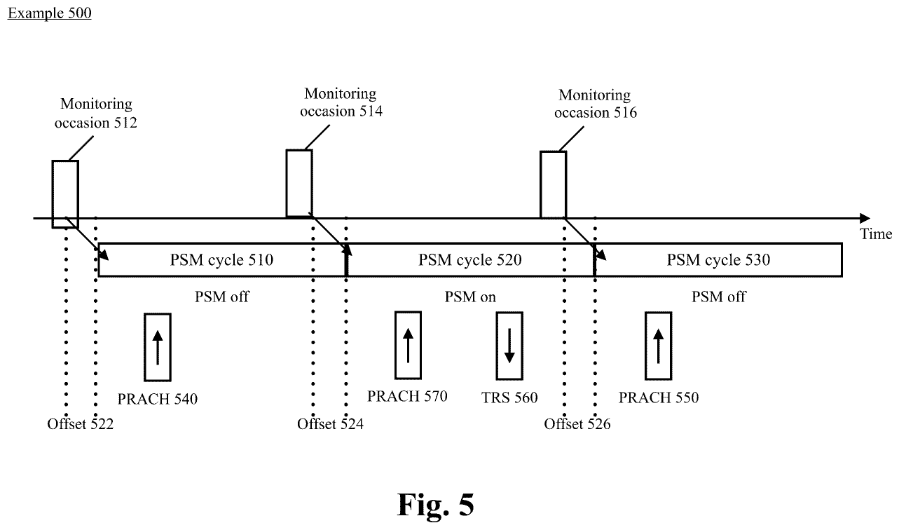

Some exemplary embodiments are described with regard to cycle-based on-off PSM. With this approach, a PSM cycle may comprise a time interval during which PSM is off or on. Each PSM cycle may correspond to a monitoring occasion for downlink control signaling (e.g., DCI format 2_X, etc.). The gNB 120A may transmit DCI during the monitoring occasion indicating whether PSM is to be used for one or more corresponding PSM cycles (e.g., off or on). One example of cycle based on-off PSM is provided below in FIG. 5.

FIG. 5 shows an example 500 of cycle-based on-off PSM operation according to various exemplary embodiments. The example 500 is described with regard to a PSM during which at least a subset of processing functionality related to TRS transmission and PRACH reception is discontinued at the gNB 120A. However, the example 500 is merely provided for illustrative purposes. Those skilled in the art will understand that there are a wide variety of different configurations that may be possible for cycle-based on-off PSM operation. For example, instead of or in addition to TRS and PRACH resources, the PSM may discontinue operations related to SRS transmission, CSI-RS reception and/or any other type of signal that may be exchanged between the gNB 120A and the UE 110. The exemplary embodiments may apply to a PSM that utilizes a cycle configured in any appropriate manner during which the gNB discontinues at least a subset of processing functionality related to the transmission and/or reception of any appropriate type of signal.

The example 500 shows three consecutive PSM cycles 510-530 each with a respective corresponding monitoring occasion for downlink control signaling 512-516. A same periodicity (P) may be applied to the monitoring occasions 512-516 and their corresponding PSM cycles 510-530. In other words, the monitoring occasions may be one-to-one mapped with PSM cycles. There may be a time offset 522-526 between the end of a monitoring occasion and the beginning of the corresponding PSM cycle. However, as indicated above, the example 500 is one of a wide variety of different configuration that may be used for cycle-based on-off PSM operation and neither a one-to-one mapping nor a time offset (fixed or dynamic) are required to be utilized. The exemplary embodiments may apply to any appropriate configuration of monitoring occasions and PSM cycles.

During monitoring occasion 512, DCI format 2_X may be transmitted by the gNB 120A. The DCI format 2_X may indicate that PSM is not being utilized by the gNB 120A during the corresponding PSM cycle 510. For example, a PSM indicator (PSMI) field in the DCI format 2_X may be set to a first value (e.g., 1) which is configured to indicate that PSM is not to be utilized during a corresponding PSM cycle. As a result, the gNB 120A may receive PRACH resource 540 during a RACH occasion from RRC connected or RRC idle UEs in relation to various different types of procedures (e.g., initial access, beam failure, etc.) because the gNB 120A is in an active mode of monitoring for PRACH resources during the RACH occasion and not in PSM.

During monitoring occasion 514, DCI format 2_X may be transmitted by the gNB 120A. The DCI format 2_X may indicate that PSM is to be utilized by the gNB 120A during the corresponding PSM cycle 520. For example, the PSMI field in the DCI format 2_X may be set to a second value (e.g., 0) which is configured to indicate that PSM is to be utilized during a corresponding PSM cycle. As a result, the gNB 120A may not transmit configured periodic TRS 560 or receive PRACH resources 570 during the PSM cycle 520 because the gNB 120A is in a sleep mode conserving power by not transmitting TRS and not monitoring for PRACH resources during RACH occasions. However, in an actual deployment scenario, the UE 110 may not actually attempt to transmit PRACH resources 570 or expect to receive TRS 560 during PSM cycle 520 because of the indication that PSM is to be utilized during the PSM cycle 520.

During monitoring occasion 516, DCI format 2_X may be transmitted by the gNB 120A. The DCI format 2_X may indicate that PSM is not be utilized by the gNB 120A during the corresponding PSM cycle 530. For example, the PSMI field in the DCI format 2_X may be set to the first value (e.g., 1) which is configured to indicate that PSM is not to be utilized during the corresponding PSM cycle. As a result, the gNB 120A may receive PRACH resource 550 because the gNB 120A is in an active mode of monitoring for PRACH resources during the RACH occasion and not in PSM.

In the example 500, there is a one-to-one mapping between PSM cycles and DCI format 2_X. Throughout this description, a parameter indicating a number of PSM cycles associated with a single instance of DCI format 2_X may be referred to as N_{PSM}. Since there is a one-to-one mapping between PSM cycles and DCI format 2_X in example 500, N_{PSM} would be set to 1. However, N_{PSM} may be set to any appropriate value. For instance, in another example, N_{PSM}∈{1,2,4,8} and one value may be selected by the network and provided to the UE 110 in a SIB (e.g., SIB1, etc.) or in another appropriate manner.

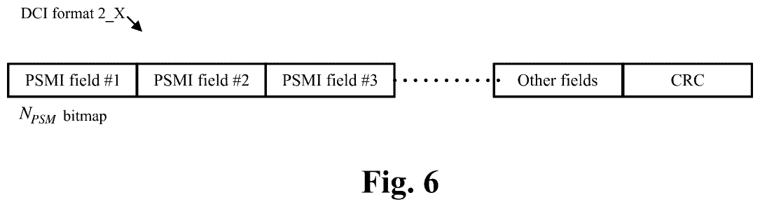

In some embodiments, the DCI format 2_X may comprise one or more PSMI fields. According to some aspects, a PSMI field of the DCI format 2_X may include a N_{PSM} bitmap and each bit may indicate a state of a PSM cycle starting from the first valid PSM cycle after the slot in which the UE 110 detects the DCI format 2_X. When a bit of the bitmap is set to a first value (e.g., 1), this may indicate that PSM is not to be utilized during the associated PSM cycle and the gNB 120A may be expected to operate in its normal mode (e.g., non-PSM) for the associated PSM cycle. When a bit of the bitmap is set to a second value (e.g., 0), this may indicate that PSM is to be utilized during the associated PSM cycle. An example of DCI format 2_X carrying this type of information is shown in FIG. 6.

FIG. 6 shows an exemplary DCI format 2_X according to various exemplary embodiments. In this example, the DCI format 2_X includes multiple PSMI fields (e.g., PSMI field #1, PSMI field #2, PSMI field #3, etc.) and other fields that may be used to carry different types of information. Each of the PSMI fields may include a N_{PSM} bitmap corresponding to different PSM cycles. In addition, the DCI format 2_X may be cyclic redundancy check (CRC) scrambling using a PSM-radio network temporary identifier (RNTI). The PSM-RNTI may be hard encoded in 3GPP Specifications or provided to the UE 110 by a SIB, RRC signaling or in any other appropriate manner. However, the exemplary embodiments are not limited to CRC or PSM-RNTI. The exemplary embodiments may utilize any appropriate scrambling techniques and any appropriate RNTI (if at all).

Some of the exemplary embodiments are described with regard to an on-off PSM (OO-PSM) pattern. A (OO-PSM) pattern may include a time interval during which PSM is to be utilized. Throughout this description, this time interval of an OO-PSM pattern may be referred to as an “on period.” The OO-PSM pattern may also include a timer interval during which PSM is not to be utilized. Throughout this description, this time interval of the OO-PSM pattern may be referred to as an “off period.”

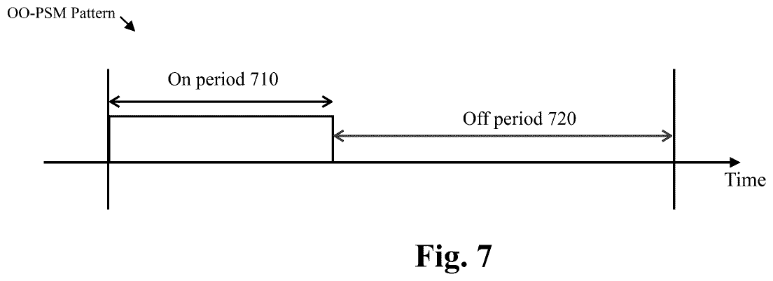

FIG. 7 shows a single OO-PSM pattern according to various exemplary embodiments. In this example, the OO-PSM pattern comprises an on period 710 during which PSM is to be utilized and an off period 720 during which PSM is not to be utilized. In some embodiments, the multiple consecutive OO-PSM patterns may occur with a periodicity.

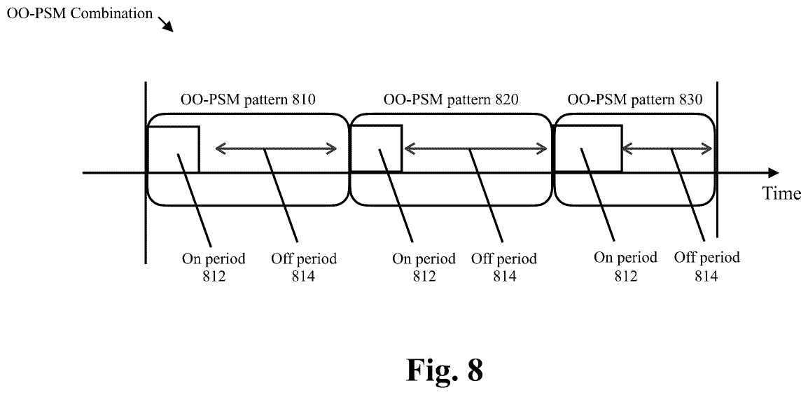

FIG. 8 shows OO-PSM combination comprising multiple OO-PSM patterns according to various exemplary embodiments. Throughout this description, a “OO-PSM combination” may refer to time duration comprising multiple consecutive OO-PSM patterns. This example shows the OO-PSM combination comprising three consecutive OO-PSM patterns 810-830 each comprising an on period 814 and an off period 814. Each PSM pattern 810-830 may on period and off period with a same or different duration. In some embodiments, consecutive OO-PSM combinations may occur with a periodicity. However, reference to an OO-PSM combination comprising three OO-PSM patterns is merely provided for illustrative purposes. The exemplary embodiments may utilize an OO-PSM combination comprising any appropriate number of OO-PSM patterns.

Information related to the OO-PSM pattern may be provided to the UE 110 utilizing the signaling diagram 400 of FIG. 4. To provide a general example, a set of OO-PSM pattern combinations may be provided to the UE 110 using the SIB in 405.

According to some aspects, a new SIB may be introduced to convey the OO-PSM pattern information. Throughout this description, this new SIB may be referred to as SIB-X. However, reference to SIB-X is merely provided for illustrative purposes, the X classification provided herein may serve as a placeholder. In an actual deployment scenario, the new SIB may be assigned any appropriate number or label. In addition, those skilled in the art will understand that a new SIB is not required. The exemplary embodiments may utilize an already defined SIB (e.g., SIB1, etc.) or any other appropriate one or more signals to provide the OO-PSM pattern information to the UE 110.

The SIB-X may explicitly or implicitly indicate to the UE 110 parameters for one or more OO-PSM patterns. For example, the SIB-X may convey parameters for an on period of an OO-PSM pattern. The parameters for the on period may include a duration measured in a number of slots, a number of symbols, a combination of slots and symbols or any other appropriate unit of time and a starting symbol of the on period. The SIB-X may also convey parameters for an off period of an OO-PSM pattern.

The parameters for the off period may include a duration measured in a number of slots, a number of symbols, a combination of slots and symbols or any other appropriate unit of time. The off period may be configured to start after the last symbol of the corresponding on period of the same OO-PSM pattern. In addition, the SIB-X may provide a periodicity (P) parameter for an OO-PSM combination and/or OO-PSM pattern. The periodicity may be used to form a PSM cycle where a OO-PSM pattern or an OO-PSM combination occurs with the indicated periodicity (P).

Subsequently, in 415, the DCI format 2_X may indicate the OO-PSM pattern combination (or pattern) to be used by the gNB 120A. In this example, the UE 110 may assume that the OO-PSM combination to be used by the gNB 120A is to start in a slot where the UE 110 detects the DCI format 2_X. However, the OO-PSM pattern or combination to be used by the gNB 120A may be configured to begin at any appropriate time relative to the DCI.

In some embodiments, the DCI format 2_X may be configured with one or more PSMI fields. The PSMI field may include a value that indicates the OO-PSM combination and/or OO-PSM pattern to be used by the gNB 120A. For example, a first value (e.g., ‘00’) may indicate that OO-PSM pattern #1 is to be utilized. A second value (e.g., ‘01’) may indicate that a combination of OO-PSM pattern #2 and OO-PSM pattern #3 are to be utilize. A third value (e.g., ‘10’) may indicate that a combination of OO-PSM pattern #4, OO-PSM pattern #5 and OO-PSM pattern #6 are to be utilized. However, this example is merely provided for illustrative purposes, the exemplary embodiments may indicate the OO-PSM pattern and/or OO-PSM combination to be utilized in any appropriate manner.

According to some aspects, for paired spectrum operation (e.g., frequency division duplex (FDD) serving cell in frequency range 1 (FR1), etc. ), a variety of different approaches may be utilized for on-off PSM operation on a downlink BWP, uplink BWP or both. In one approach, a shared OO-PSM pattern combination may be utilized where a single OO-PSM pattern combination may be indicated by a value in a PSMI field of the DCI format 2_X which is to be commonly applied for both uplink BWP and downlink BWP for a period of time.

In another approach, separate OO-PSM pattern combinations may be used for downlink BWP and uplink BWP. With this approach, one or more PSMI fields in the DCI format 2_X may indicate a OO-PSM pattern combination for downlink BWP and/or an OO-PSM pattern combination for uplink BWP. An example of a mapping between a value of a PSMI field of the DCI format 2_X and the corresponding OO-PSM patterns using this exemplary approach is provided below in the table 900 of FIG. 8.

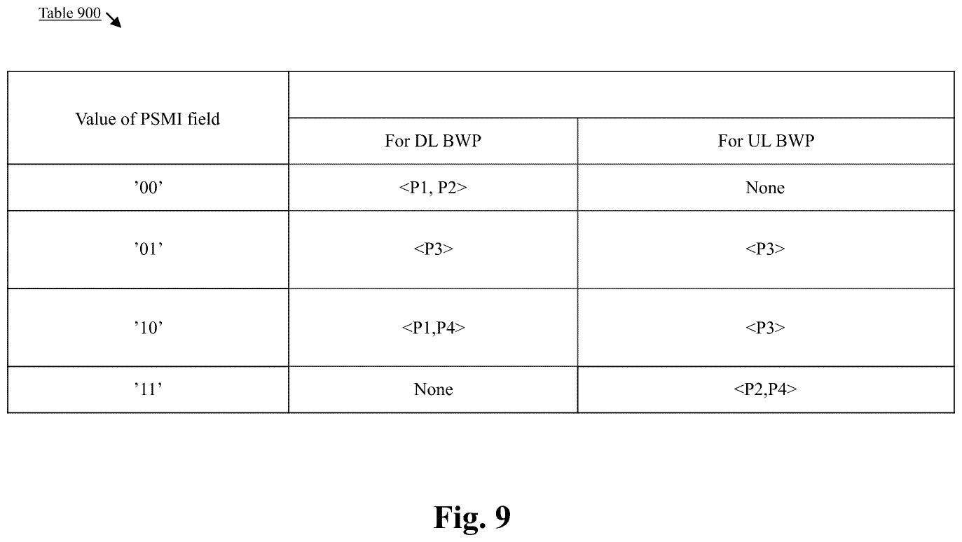

FIG. 9 shows a table 900 according to various exemplary embodiments. The table 900 includes a value that may be included in a PSMI field of the DCI format 2_X. The value of the PSMI field may be mapped to one or more of an OO-PSM combination and/or pattern for uplink BWP and an OO-PSM combination and/or pattern for downlink BWP. Thus, the DCI format 2_X PSMI field value may be used to dynamically indicate any appropriate OO-PSM combination and/or pattern that was semi-statically configured by the network.

In the table 900, the PSMI field value ‘00’ indicates that an OO-PSM combination of OO-PSM pattern #1 (P1) and OO-PSM pattern #2 (P2) may be utilized for a downlink BWP. In this example, this value only indicates an OO-PSM combination for a downlink BWP and does not provide any information related to the uplink BWP. The PSMI field value ‘01’ indicates that OO-PSM pattern #3 (P3) may be utilized for both the downlink BWP and the uplink BWP. The PSMI field value ‘10’ indicates that OO-PSM combination of OO-PSM pattern #1 (P1) and OO-PSM pattern #4 (P4) may be utilized for the downlink BWP and OO-PSM pattern #3 (P3) may be utilized for the uplink BWP. Thus, the downlink BWP and the uplink BWP may utilize different OO-PSM patterns. The PSMI field value ‘11’ indicates that an OO-PSM combination of OO-PSM pattern #2 (P2) and OO-PSM pattern #4 (P4) may be utilized for the uplink BWP. In this example, this value only indicates an OO-PSM combination for the uplink BWP and does not provide any information related to the downlink BWP. The table 900 is not intended to limit the exemplary embodiments in any way, the PSMI field may utilize any appropriate value to dynamically indicate an OO-PSM combination and/or pattern.

### Examples

In a first example, a method is performed by a user equipment (UE), comprising receiving a system information block (SIB) comprising information related to a downlink control information (DCI) that is transmitted by a base station and receiving the DCI indicating when the base station is to utilize a power saving mode comprising at least one time interval during which the base station discontinues the transmission or reception of a type of periodic or semi-persistent signal.

In a second example, the method of the first example, wherein the SIB comprises at least one of a power saving mode radio network temporary identifier (RNTI) for the DCI and a payload size of the DCI.

In a third example, the method of the first example, wherein the SIB comprises information indicating a configuration of a search space set to be used by the UE to monitor physical downlink control channel (PDCCH) for detection of the DCI.

In a fourth example, the method of the first example, wherein the SIB comprises information indicating a location within the DCI for a starting position of a power saving mode indication (PSMI) field associated with a serving cell of the UE.

In a fifth example, the method of the first example, wherein the DCI corresponds to one or more power saving mode cycles and the PSM field of the DCI indicates whether power saving mode is on or off during the one or more power saving mode cycles for a serving cell.

In a sixth example, the method of the first example, further comprising, when power saving mode is on during the one or more power saving mode cycles, the UE is configured to discontinue one or more operations related to transmitting a periodic or semi-persistent signals to the base station or receiving the periodic or semi-persistent signal from the base station.

In a seventh example, the method of the sixth example, wherein the one or more operations comprise at least one of transmitting physical random access channel (PRACH) resources, transmitting configured grant physical uplink shared channel (PUSCH), transmitting physical uplink control channel (PUCCH) and transmitting sounding reference signals (SRS).

In an eighth example, the method of the sixth example, wherein the one or more operations comprise at least one of measuring channel state information (CSI) reference signal (CSI-RS) resources, reporting periodic CSI, reporting semi-persistent CSI and reporting aperiodic CSI.

In a ninth example, the method of the sixth example, wherein the one or more operations comprise at least one of monitoring physical downlink control channel (PDCCH) and receiving synchronization signal blocks (SSBs).

In a tenth example, the method of the first example, wherein the DCI comprises a power saving mode indicator (PSMI) field containing a bitmap, wherein each bit of the bitmap corresponds to a power saving mode cycle for on or off indication.

In an eleventh example, the method of the first example, wherein the SIB comprises a set of on-off power saving mode (OO-PSM) patterns, each OO-PSM pattern comprising an on period during which the PSM is not to be utilized and an off period during which PSM is to be utilized.

In a twelfth example, the method of the eleventh example, wherein the DCI comprises a power saving mode indicator (PSMI) field containing a value indicating which one or more OO-PSM patterns are to be utilized by the base station.

In a thirteenth example, the method of the twelfth example, wherein OO-PSM patterns indicated by the value of PSMI field in the DCI are applied to both a downlink bandwidth part (BWP) and an uplink BWP, or only the downlink BWP or only the uplink BWP, which is indicated by radio resource control (RRC) signaling or the DCI.

In a fourteenth example, the method of the eleventh example, further comprising, when an on period of an OO-PSM pattern occurs, the UE is configured to discontinue one or more operations related to transmitting or receiving a periodic or semi-persistent signal to or from the base station.

In a fifteenth example, the method of the fourteenth example, wherein the one or more operations comprise at least one of transmitting physical random access channel (PRACH) resources, transmitting configured grant physical uplink shared channel (PUSCH), transmitting physical uplink control channel (PUCCH) and transmitting sounding reference signals (SRS).

In a sixteenth example, the method of the fourteenth example, wherein the one or more operations comprise at least one of measuring channel state information (CSI) reference signal (CSI-RS) resources, reporting periodic CSI, reporting semi-persistent CSI and reporting aperiodic CSI.

In a seventeenth example, the method of the fourteenth example, wherein the one or more operations comprise at least one of monitoring physical downlink control channel (PDCCH) and receiving synchronization signal blocks (SSBs).

In an eighteenth example, a processor configured to perform any of the methods of the first through seventeenth examples.

In a nineteenth example, a user equipment (UE) comprising a transceiver configured to communicate with a network and a processor communicatively coupled to the transceiver and configured to perform any of the methods of the first through seventeenth examples.

In a twentieth example, a method is performed by a base station, comprising transmitting a system information block (SIB) comprising information related to a downlink control information (DCI) that is transmitted to a user equipment (UE) and transmitting the DCI indicating when the base station is to utilize a power saving mode comprising at least one time interval during which the base station discontinues the transmission or reception of a type of periodic or semi-persistent signal.

In a twenty first example, the method of the twentieth example, wherein the SIB comprises at least one of a power saving mode radio network temporary identifier (RNTI) for the DCI and a payload size of the DCI.

In a twenty second example, the method of the twentieth example, wherein the SIB comprises information indicating a configuration of a search space set to be used by the UE to monitor physical downlink control channel (PDCCH) for detection of the DCI.

In a twenty third example, the method of the twentieth example, wherein the SIB comprises information indicating a location within the DCI for a starting position of a power saving mode indication (PSMI) field associated with a serving cell of the UE.

In a twenty fourth example, the method of the twentieth third, wherein the DCI corresponds to one or more power saving mode cycles and the PSMI field in the DCI indicates whether power saving mode is on or off during the one or more power saving mode cycles for a serving cell.

In a twenty fifth example, the method of the twentieth example, wherein the DCI comprises a power saving mode indicator (PSMI) field containing a bitmap, wherein each bit of the bitmap corresponds to a power saving mode cycle for on or off indication.

In a twenty sixth example, the method of the twentieth example, wherein the SIB comprises a set of on-off power saving mode (OO-PSM) patterns, each OO-PSM pattern comprising an on period during which the PSM is not to be utilized and an off period during which PSM is to be utilized.

In a twenty seventh example, the method of the twenty sixth example, wherein the DCI comprises a power saving mode indicator (PSMI) field containing a value indicating which one or more OO-PSM patterns are to be utilized by the base station.

In a twenty eighth example, the method of the twenty seventh example, wherein the OO-PSM patterns indicated by the value of PSMI field in the DCI are applied to both a downlink bandwidth part (BWP) and an uplink BWP, or only the downlink BWP or only the uplink BWP which is indicated by radio resource control (RRC) signaling or the DCI.

In a twenty ninth example, a processor configured to perform any of the methods of the twentieth through twenty eighth examples.

In thirtieth example, a base station comprising a transceiver configured to communicate with a user equipment (UE) and a processor communicatively coupled to the transceiver and configured to perform any of the methods of the twentieth through twenty eighth examples.

Those skilled in the art will understand that the above-described exemplary embodiments may be implemented in any suitable software or hardware configuration or combination thereof. An exemplary hardware platform for implementing the exemplary embodiments may include, for example, an Intel x86 based platform with compatible operating system, a Windows OS, a Mac platform and MAC OS, a mobile device having an operating system such as iOS, Android, etc. The exemplary embodiments of the above described method may be embodied as a program containing lines of code stored on a non-transitory computer readable storage medium that, when compiled, may be executed on a processor or microprocessor.

Although this application described various embodiments each having different features in various combinations, those skilled in the art will understand that any of the features of one embodiment may be combined with the features of the other embodiments in any manner not specifically disclaimed or which is not functionally or logically inconsistent with the operation of the device or the stated functions of the disclosed embodiments.

It is well understood that the use of personally identifiable information should follow privacy policies and practices that are generally recognized as meeting or exceeding industry or governmental requirements for maintaining the privacy of users. In particular, personally identifiable information data should be managed and handled so as to minimize risks of unintentional or unauthorized access or use, and the nature of authorized use should be clearly indicated to users.

It will be apparent to those skilled in the art that various modifications may be made in the present disclosure, without departing from the spirit or the scope of the disclosure. Thus, it is intended that the present disclosure cover modifications and variations of this disclosure provided they come within the scope of the appended claims and their equivalent.

What is claimed:

1. An apparatus of a user equipment (UE), the apparatus comprising processing circuitry configured to:
decode, based on signaling received from a base station, a system information block (SIB) comprising information related to a downlink control information (DCI) that is transmitted by the base station; and
decode, based on signaling received from the base station, the DCI indicating when the base station is to utilize a power saving mode comprising at least one time interval during which the base station discontinues the transmission or reception of a type of periodic or semi-persistent signal.

2. The apparatus of claim 1, wherein the SIB comprises at least one of a power saving mode radio network temporary identifier (RNTI) for the DCI and a payload size of the DCI.

3. The apparatus of claim 1, wherein the SIB comprises information indicating a configuration of a search space set to be used by the UE to monitor physical downlink control channel (PDCCH) for detection of the DCI.

4. The apparatus of claim 1, wherein the SIB comprises information indicating a location within the DCI for a starting position of a power saving mode indication (PSMI) field associated with a serving cell of the UE.

5. The apparatus of claim 1, wherein the DCI corresponds to one or more power saving mode cycles and the PSM field of the DCI indicates whether power saving mode is on or off during the one or more power saving mode cycles for a serving cell.

6. The apparatus of claim 1, wherein the processing circuitry is further configured to:
when power saving mode is on during the one or more power saving mode cycles, discontinue one or more operations related to transmitting a periodic or semi-persistent signals to the base station or receiving the periodic or semi-persistent signal from the base station.

7. The apparatus of claim 6, wherein the one or more operations comprise at least one of transmitting physical random access channel (PRACH) resources, transmitting configured grant physical uplink shared channel (PUSCH), transmitting physical uplink control channel (PUCCH) and transmitting sounding reference signals (SRS).

8. The processor of claim 6, wherein the one or more operations comprise at least one of measuring channel state information (CSI) reference signal (CSI-RS) resources, reporting periodic CSI, reporting semi-persistent CSI and reporting aperiodic CSI.

9. The apparatus of claim 6, wherein the one or more operations comprise at least one of monitoring physical downlink control channel (PDCCH) and receiving synchronization signal blocks (SSBs).

10. The apparatus of claim 1, wherein the DCI comprises a power saving mode indicator (PSMI) field containing a bitmap, wherein each bit of the bitmap corresponds to a power saving mode cycle for on or off indication.

11. The apparatus of claim 1, wherein the SIB comprises a set of on-off power saving mode (OO-PSM) patterns, each OO-PSM pattern comprising an on period during which the PSM is not to be utilized and an off period during which PSM is to be utilized.

12. The apparatus of claim 11, wherein the DCI comprises a power saving mode indicator (PSMI) field containing a value indicating which one or more OO-PSM patterns are to be utilized by the base station.

13. The apparatus of claim 12, wherein OO-PSM patterns indicated by the value of PSMI field in the DCI are applied to both a downlink bandwidth part (BWP) and an uplink BWP, or only the downlink BWP or only the uplink BWP, which is indicated by radio resource control (RRC) signaling or the DCI.

14. The apparatus of claim 11, wherein the processing circuitry is further configured to:
when an on period of an OO-PSM pattern occurs, discontinue one or more operations related to transmitting or receiving a periodic or semi-persistent signal to or from the base station.

15. The apparatus of claim 14, wherein the one or more operations comprise at least one of transmitting physical random access channel (PRACH) resources, transmitting configured grant physical uplink shared channel (PUSCH), transmitting physical uplink control channel (PUCCH) and transmitting sounding reference signals (SRS).

16. The apparatus of claim 14, wherein the one or more operations comprise at least one of measuring channel state information (CSI) reference signal (CSI-RS) resources, reporting periodic CSI, reporting semi-persistent CSI and reporting aperiodic CSI.

17. The apparatus of claim 14, wherein the one or more operations comprise at least one of monitoring physical downlink control channel (PDCCH) and receiving synchronization signal blocks (SSBs).

18. An apparatus of a base station, the apparatus comprising processing circuitry configured to:
configure transceiver circuitry to transmit a system information block (SIB) comprising information related to a downlink control information (DCI) that is transmitted to a user equipment (UE) ; and
configure transceiver circuitry to transmit the DCI indicating when the base station is to utilize a power saving mode comprising at least one time interval during which the base station discontinues the transmission or reception of a type of periodic or semi-persistent signal.

19. The apparatus of claim 18, wherein the SIB comprises at least one of a power saving mode radio network temporary identifier (RNTI) for the DCI and a payload size of the DCI.

20. The apparatus of claim 18, wherein the SIB comprises information indicating a configuration of a search space set to be used by the UE to monitor physical downlink control channel (PDCCH) for detection of the DCI.
